(19) United States
(12) Patent Application Publication
(10) Pub. No.: US 2019/0100083 A1
(43) Pub. Date: Apr. 4, 2019

(54) CONTROLLING SUN LOAD IN AN AUTONOMOUS VEHICLE TO CONSERVE ENERGY

(71) Applicant: Ford Global Technologies, LLC, Dearborn, MI (US)

(72) Inventors: Mahmoud Yousef Ghannam, Canton, MI (US); John Robert Van Wiemeersch, Novi, MI (US)

(21) Appl. No.: 15/724,014

(22) Filed: Oct. 3, 2017

(51) Int. Cl. B60J 3/04; B60N 2/00; G07C 5/08; G05D 1/00

(52) U.S. Cl. CPC B60J 3/04; B60N 2/002; B60W 2560/00; G05D 1/0088; G07C 5/08

(57) ABSTRACT

Method and apparatus are disclosed for controlling sun load in an autonomous vehicle to conserve energy. An example vehicle includes photochromic windows and a processor. The processor (a) determines a difference between an external ambient temperature and a cabin temperature, (b) when the difference is greater than a threshold, individually set tint levels on the photochromic windows to reduce a sun load on an interior of vehicle based on a driving mode and occupancy, and (c) in response to detecting a emergency, clear the tint levels on all the photochromic windows.

### TECHNICAL FIELD

The present disclosure generally relates to heating and air conditioning systems in a vehicle and, more specifically, controlling sun load in an autonomous vehicle to conserve energy.

### BACKGROUND

Increasingly, autonomous vehicles are battery electric vehicles (BEVs) that operate with a finite amount of energy stored in an array of batteries. Recharging these autonomous vehicles can take a long time when compared to standard fuel vehicles. The heating, ventilation, and air conditioning (HVAC) system of a vehicle provides a comfortable atmosphere for occupants but draws significant power. Additionally, because autonomous vehicles may be empty as they travel from one destination to another, maintaining the temperature in the cabin can be wasteful. However, the cabin still should be comfortable when passengers enter the vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are disclosed for controlling sun load in an autonomous vehicle to conserve energy. An example vehicle includes photochromic windows and a processor. The processor (a) determines a difference between an external ambient temperature and a cabin temperature, (b) when the difference is greater than a threshold, individually set tint levels on the photochromic windows to reduce a sun load on an interior of vehicle based on a driving mode and occupancy, and (c) in response to detecting an emergency, clear the tint levels on all the photochromic windows.

An example method to control sun load on an interior of a vehicle includes determining a difference between an external ambient temperature and a cabin temperature. The example method also includes, when the difference is greater than a threshold, setting, via photochromic controllers, tint levels on one or more photochromic windows of the vehicle to reduce the sun load based on a driving mode and occupancy. Additionally, the example method includes, in response to detecting an emergency, clear, with the photochromic controllers, the tint levels on all the photochromic windows.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example autonomous vehicle operating in accordance with the teachings of this disclosure.

FIG. 2 is a block diagram of electronic components of the autonomous vehicle of FIG. 1.

FIG. 3 is a flowchart of a method to regulate the temperature of a cabin of the vehicle of FIG. 1, which may be implemented by the electronic components of FIG. 2.

FIG. 4 is a flowchart of a method to manage solar radiation into the cabin of the autonomous vehicle of FIG. 1, which may be implemented by the electronic components of FIG. 2.

FIG. 5 is a flowchart of a method to cultivate solar radiation into the cabin of the autonomous vehicle of FIG. 1, which may be implemented by the electronic components of FIG. 2.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Autonomous vehicles have system that autonomously control the motive functions of the vehicle without direct human input. Because the vehicles are autonomous, they can move around transporting passengers without sitting in a parking spot for a long period of time. The autonomous vehicles can reposition themselves to locations in anticipation of demand or in route to picking up passengers. In such scenarios, the autonomous vehicles may have not occupants. It is desirable for the cabin to be at a comfortable temperature when passengers are picked up. However, to save battery power, it is also desirable to not engage the heating, ventilation, and air conditioning (HVAC) system when there are not passengers.

In general, windshields are designed to protect the occupants of the vehicle from debris and provide and aerodynamic shape to reduce drag forces. The glass in the windows may be laminated or tempered to protect occupants during a collision. Additionally, windows in the vehicles provide visibility to the drivers. Different jurisdictions have different laws regarding tinting on vehicle windows. Often, the tint of a window is specified by the transparency of the window with the ting applied. For example, many jurisdictions prohibit applying a tint to windshields and limit the tinting (e.g., at least 70% transparency) on the rear, roof, and side windows. The restrictions on minimum transparency originate from the need for drivers to have optimized forward visibility at night and also out the side and rear windows for optimized use of mirrors. Because many trucks have solid rear cargo zones, this requirement on tinting is not enforced rear of the B-pillar for trucks (SUV and Cross-over vehicles are classified as trucks). However, in the case of an autonomous vehicle, visibility needs are confined to the optical aperture of the camera or LiDAR device thus allowing greater tinting levels for all glazing surfaces including the windshield.

As disclosed below, an autonomous vehicle includes windows that incorporate a photochromic or liquid crystal layer that controls the tinting level of the window from 0% to 100% transparency. The autonomous vehicle controls the tinting of each window individually. In some examples, the each window may be divided into multiple zones in which the level of tint can be individually controlled. Changing the tinting of the windows controls the sun load in the cabin of the vehicle cause by solar radiation. To conserve energy, the autonomous vehicle controls the HVAC system and the transparency of the windows. For example, when the external ambient temperature is greater than a desired cabin temperature, the vehicle may control the tinting to block solar radiation from heating the cabin to lower the demand on the air conditioner of the HVAC system. As another example, when the external ambient temperature is less than the desired cabin temperature, the vehicle may control the transparency of the windows to cultivate solar radiation to reduce the demand on the heater of the HVAC system. In such a manner, the vehicle conserves power used by the HVAC system to improve performance and range of the vehicle.

The vehicle uses several factors to determine (a) the tinting level (e.g., from 0% tinting to 100% tinting) for the windows and (b) to which windows to apply different tinting levels. In some examples, the vehicle uses (i) the external ambient temperature, (ii) the cabin temperature, (iii) a cabin temperature set point, (iv) the current vehicle sun load, (v) the current driving function of the vehicle (e.g., driving, parked, etc.), (vi) a state-of-charge (SoC) of the battery, (vii) the driving mode of the vehicle (e.g., an autonomous mode, a manual driving mode, etc.), (viii) the number and location of occupants of the vehicle, (ix) the weather, (x) jurisdiction laws, and/or (xi) the presence of emergency conditions, etc. Based on the factors, the vehicle continuously adjusts the tinting to adapt to changes in the conditions around the vehicle. Additionally, in some examples, the system responds to requests from occupants. For example, when the occupants indicate (e.g., via an infotainment system, etc.) that they want fresh air, the vehicle may control the window tinting and open non-tinted windows.

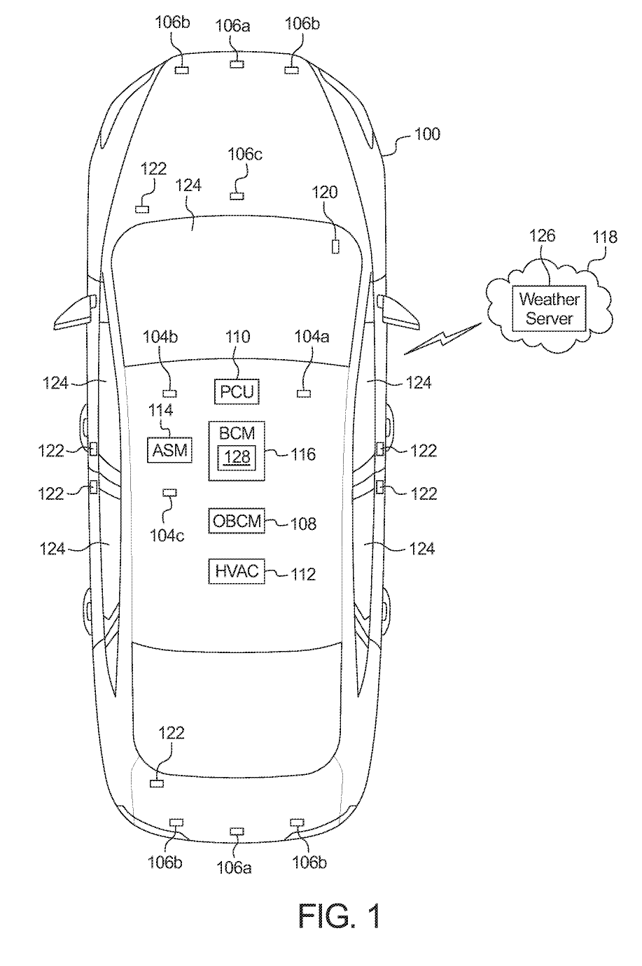

FIG. 1 illustrates an example autonomous vehicle 100 operating in accordance with the teachings of this disclosure. The autonomous vehicle 100 is an electric vehicle. The autonomous vehicle 100 includes parts related to mobility, such as a power train with an electric motor, a transmission, a suspension, a driveshaft, and/or wheels, etc. The motive functions of the autonomous vehicle are controlled without direct input from a driver. In some examples, the autonomous vehicle 100 includes different automated driving modes, occupant-selectable driving modes, such as a fully autonomous mode, an driver assist mode (e.g., certain motive functions are controlled by the autonomous vehicle 100, etc.), and a manual driving mode. In the illustrated example the autonomous vehicle includes internal sensors 104a-104c, external sensors 106, an on-board communications module (OBCM) 108, a powertrain control unit (PCU) 110, a heating, ventilation, and air conditioning (HVAC) control module 112, an active safety module (ASM) 114, and a body control module (BCM) 116.

The internal sensors 104a-104c monitor conditions in the cabin of the autonomous vehicle 100. The internal sensors 104a-104c include one or more cameras 104a, one or more weight sensors 104b, and/or a temperature sensor 104c. The camera(s) 104a monitor the cabin to determine whether the autonomous vehicle 100 is occupied and, when occupied, the location(s) (e.g., seating positions) of the occupant(s) inside the autonomous vehicle 100. The weight sensor(s) monitor seats in the autonomous vehicle 100 to determine whether the autonomous vehicle 100 is occupied and, when occupied, the location(s) (e.g., seating positions) of the occupant(s) inside the autonomous vehicle 100. The temperature sensor 104c monitors the temperature inside the cabin of the autonomous vehicle 100.

The external sensors 106a-106c monitor conditions in the external area proximate the autonomous vehicle 100. The external sensors 106a-106c include one or more external cameras 106a, range detection sensors 106b (e.g., ultrasonic sensors, RADAR, and/or LiDAR, etc.), and/or an external temperature sensor 106c. The camera(s) 106a and the range detection sensors 106b are used (e.g., by the active safety module 114) to determine the characteristics of the environment around the autonomous vehicle 100 to facilitate autonomous navigation. The external temperature sensor 106c measures the ambient temperature of the area around the autonomous vehicle 100. Alternatively or additionally, in some examples, the ambient temperature of the area around the autonomous vehicle 100 is provided by a weather server.

The on-board communications module 108 facilitates the autonomous vehicle communicating with mobile devices (e.g., smart phones, smart watches, etc.), other vehicles, and/or external networks 118 to obtain data about the environment in which the autonomous vehicle 100 is traversing, obtain user preferences, and/or assist autonomous navigation, etc. The on-board communications module 108 includes wired or wireless network interfaces to enable communication with external networks. The on-board communications module 108 also includes hardware (e.g., processors, memory, storage, antenna, etc.) and software to control the wired or wireless network interfaces. In the illustrated example, the on-board communications module 108 includes one or more communication controllers for standards-based networks, such as cellular networks (e.g., Global System for Mobile Communications (GSM), Universal Mobile Telecommunications System (UMTS), Long Term Evolution (LTE), Code Division Multiple Access (CDMA), etc.), wide area networks (e.g., WiMAX (IEEE 802.16m), Wireless Gigabit (IEEE 802.11ad), etc.), local area wireless network (including IEEE 802.11 a/b/g/n/ac or others), personal area networks (e.g., Bluetooth®, Bluetooth® Low Energy, Z-Wave®, Zigbee®, etc.) and/or vehicle-to-vehicle networks (e.g., dedicated short range communication (DSRC), etc.), etc. In some examples, the on-board communications module 108 includes a wired or wireless interface (e.g., an auxiliary port, a Universal Serial Bus (USB) port, a Bluetooth® wireless node, etc.) to communicatively couple with a mobile device (e.g., a smart phone, a smart watch, a tablet, etc.). In such examples, the autonomous vehicle 100 may communicated with the external network 118 via the coupled mobile device. The external network(s) 118 may be a public network, such as the Internet; a private network, such as an intranet; or combinations thereof, and may utilize a variety of networking protocols now available or later developed including, but not limited to, TCP/IP-based networking protocols.

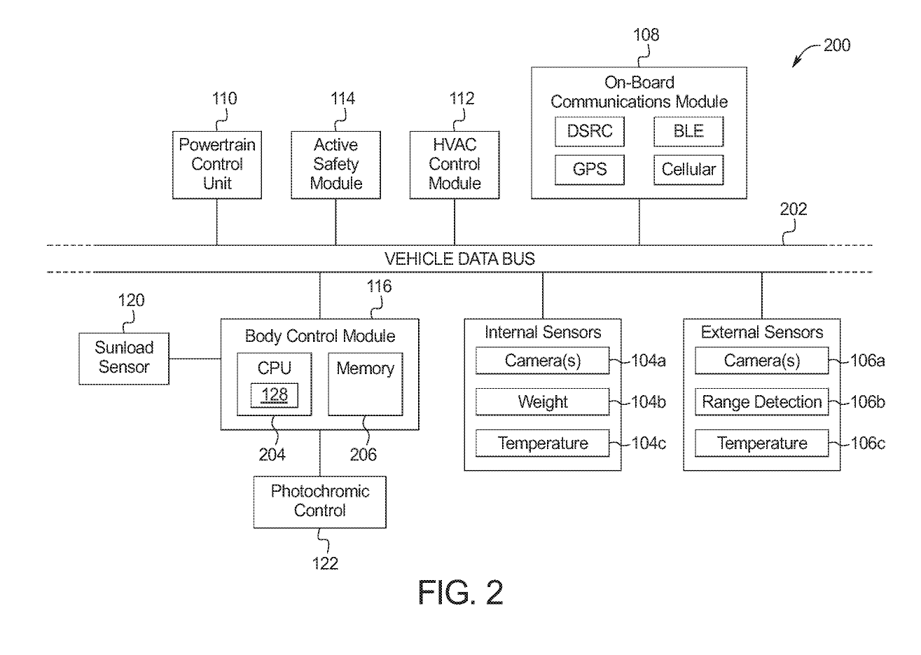

The powertrain control unit 110 controls the motor, the transmission, and the power system of the autonomous vehicle 100. The active safety module 114 controls the autonomous navigation of the autonomous vehicle 100 with information from the external sensors 106a and 106b and/or the on-board communications module 108. The active safety module 114 communicates (e.g., via the vehicle data bus 202 of FIG. 2 below) the state of the autonomous vehicle 100 (e.g., whether the vehicle is in full autonomous mode, driver assist mode, driver control mode, moving, parking, etc.).

The HVAC control module 112 controls the components of an HVAC system (e.g., heaters, blowers, duct gates, vents, injectors, chillers, and filters that control the temperature, quality, and routing of the air circulating in the cabin of the vehicle, etc.) accordingly to influence the internal cabin temperature according to its settings. These settings may be received from an occupant's physical or virtual controls on a center console, a mobile device communicatively coupled to the on-board communications module 108, and/or internal memory. In some examples, the internal memory contains settings for the HVAC control module 112 based on, for example, whether the autonomous vehicle 100 is occupied and when the autonomous vehicle 100 is next expected to be occupied. The HVAC control module 112 communicates (e.g., via the vehicle data bus 202 of FIG. 2 below) the state of the HVAC system.

The body control module 116 controls various subsystems of the autonomous vehicle 100. For example, the body control module 116 may control power windows, power locks, an immobilizer system, and/or power mirrors, etc. The body control module 116 includes circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc. In the illustrated example, the body control modules is communicatively coupled to a sunload sensor 120 and photochromic controls 122 for each window 124. The sunload sensor 120 measures the energy (in Watts per meter squared (W/m²)) of solar radiation affecting the autonomous vehicle 100. Alternatively or additionally, in some examples, the body control module 116 receives the sun load from a weather server 126 via the external network 118.

The photochromic controls 122 control, from 0% transparency to 100% transparency, the level of tinting for each window 124. The windows 124 incorporate a photochromic or liquid crystal layer between a glass layer and a plastic layer. Photochromic controls 122 control the transparency of the window 124 by varying the voltage to the photochromic or liquid crystal layer. In some examples, the photochromic controls 122 includes a signal generator electrically coupled to the photochromic or liquid crystal layer to vary the transparency of the corresponding window 124 in proportion to a respective drive voltage signal. The transparency affects the contribution of the sun load to the internal temperature of the autonomous vehicle 100. Because each window has a separate photochromic control 122, the body control module 116 can change the tint level of each window independently

The body control module 116 includes a tint controller 128. The tint controller 128 controls the tint of the windows 124 based on (i) the external ambient temperature, (ii) the cabin temperature, (iii) a cabin temperature set point, (iv) the current vehicle sun load, (v) the current driving function of the vehicle (e.g., driving, parked, etc.), (vi) a state-of-charge (SoC) of the battery, (vii) the driving mode of the vehicle (e.g., an autonomous mode, a manual driving mode, etc.), (viii) the number and location of occupants of the vehicle, (ix) the weather, (x) jurisdiction laws, and/or (xi) the presence of emergency conditions, etc.

The tint controller 128 controls the tint level, via the photochromic controls 122, based on whether the current conditions indicate to block the sun load (sometimes referred to as a “blocking mode”) or to cultivate heat (sometime referred to as a “cultivation mode”). Additionally, the tint controller 128 considers the driving mode, the location(s) of occupant(s) in the cabin, and whether emergency conditions are present to determine the level of tint. Additionally, in some examples, the tint of the windows 124 is manually adjustable by the occupants via a physical or virtual interface on, for example, the center console.

When a desired cabin temperature is less than the external ambient temperature, the tint controller 128 switches to blocking mode. When the desired cabin temperature is greater than the external ambient temperature, the tint controller 128 switches to cultivation mode. In blocking mode, the tint controller determines whether there is a sun load (e.g., via the sunload sensor 120, etc.) and/or the weather is sunny (e.g., via the weather server 126). Hereafter, the term sunny is being used an indication of sun load. Even an overcast day may generate sufficient sun load for the vehicle tint controller 128 to consider the day “sunny”. However, on the same day with the same level of overcast cloud cover, the sun load at mid-morning or late afternoon may be characterized as not sunny due to reduced sun load resulting from the lower angles of the sun. Conversely, the level of sun load on an overcast day can also vary significantly based on the position of the vehicle on the earth (i.e., equator versus pole regions). The tint controller 128 does not change the tint level of the windows 124 when there is not a sun load and/or the weather is not sunny. When the autonomous vehicle 100 is not in autonomous mode, there are occupants in the cabin, or there are emergency conditions, the tint controller 128 controls the tint level of the windows 124 between 100% transparency and 0% transparency. As discussed below, the tint controller 128 uses several factors to determine which windows 124 are tinted at which amount. When the autonomous vehicle 100 is in autonomous mode, there are no occupants in the cabin, and there are no emergency conditions, the tint controller 128 fully tints the windows (e.g., 0% transparency, 10% transparency, etc.) except for apertures required by cabin cameras used for forward looking views and/or side and reverse maneuvers. As used herein, the term “fully tinted” refers to the maximum amount of tint level that as defined by the tint controller 128 for each of the windows 124. For example, a fully tinted windshield may have a tint level of 15% transparency to accommodate externally facing cabin cameras and a fully tinted sun/moon roof may have a transparency of 0%. In some examples, to detect emergency conditions, the tint controller 128 performs image recognition based on images captured by the external camera 106a, responds to a collision indicator communicated by a restraint control module (RCM), and/or receives an indication via vehicle-to-vehicle communication.

In cultivation mode, the tint controller 128 does not change the tint level of the windows 124 when there is not a sun load and/or the weather is not sunny. When the autonomous vehicle 100 is not in autonomous mode or there are occupants in the cabin, the tint controller 128 controls the tint level of the windows 124 between 100% transparency and 0% transparency. As discussed below, the tint controller 128 uses several factors to determine which windows 124 are tinted at which amount. When there are emergency conditions, the tint controller 128 sets the tint level of the windows to 100% transparency. When there are not emergency conditions, the tint controller 128 does not further adjust the tint level of the windows 124.

When determining a tinting level for the windows 124, the tint controller 128 considers many factors. When the autonomous vehicle 100 is not in autonomous mode, the tint controller 128 sets the tint level in accordance with the laws of the local jurisdiction. When occupants are in the cabin, the tint controller 128 sets the tint level and selects which windows 124 to apply the tint to considering the location of the occupants. For example, when the tint level is to be increased to block solar radiation, the tint controller 128 may increase the tint level greater on windows 124 that are not proximate the occupants more than the windows 124 that are proximate the occupants. An another example, based on the position of the sun, the orientation of the autonomous vehicle 100, and the position of the occupants, the tint controller 128 may set the tint levels on the windows 124 to block sun from shining on the occupants while facilitating a view through other windows 124. In some examples, when the solar radiation is to be blocked, the tint controller 128 increases the tint level of the windows in which the sun is shining into the autonomous vehicle 100 (e.g., based on the position of the sun and the orientation of the autonomous vehicle 100) and vice versa when the solar radiation is to be cultivated. Additionally, in some examples, the tint controller 128 continually monitors and adjusts the tint level of the windows 124. For example, after initially setting the tint level of the windows 124, if the cabin temperature continues to rise, the tint controller 128 may further decrease the transparency of the windows 124.

In some examples, upon receiving a request to open one of the windows 124, the tint controller 128 selects one or more of the windows to open based on the effect on the sun load to the interior of the autonomous vehicle 100. In some such examples, the tint controller 128 opens one or more of the windows 124 that are not tinted. Alternatively, in some such examples, the tint controller 128 opens one or more of the windows 124 that have the highest amount of transparency. For example, if the windows 124 on the right side of the autonomous vehicle 100 are set with a tint level to have a transparency of 30% because of the direction of travel of the autonomous vehicle 100 and the angle of the sun and the windows 124 on the right side of the autonomous vehicle 100 are set with a tint level to have a transparency of 70%, the tint controller 128 may cause the windows on the left side of the autonomous vehicle 100 to open.

FIG. 2 is a block diagram of electronic components 200 of the autonomous vehicle 100 of FIG. 1. In the illustrated example, the electronic components 200 include the internal sensors 104a-104c, external sensors 106a-106c, the on-board communications module 108, the powertrain control unit 110, the HVAC control module 112, the active safety module 114, the body control module 116, and a vehicle data bus 202.

The body control module 116 includes a processor or controller 204 and memory 206. In the illustrated example, the body control module 116 is structured to include tint controller 128. The processor or controller 204 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 206 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory 206 includes multiple kinds of memory, particularly volatile memory and non-volatile memory. In some examples, the memory 206 stores a lookup table that associated an orientation of the vehicle, the location of the vehicle (e.g. via coordinates generated by a global positioning system (GPS) receiver), the time of date, and the date with a position of the sun.

The memory 206 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 206, the computer readable medium, and/or within the processor 204 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

The vehicle data bus 202 communicatively couples the internal sensors 104a-104c, external sensors 106a-106c, the on-board communications module 108, the power train control unit 110, the HVAC control module 112, the active safety module 114, and/or the body control module 116. In some examples, the vehicle data bus 202 includes one or more data buses. The vehicle data bus 202 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

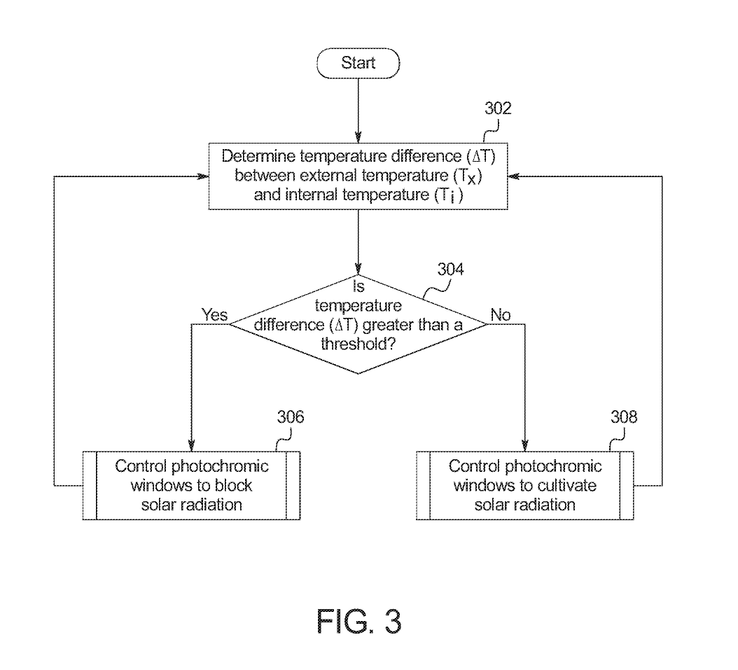

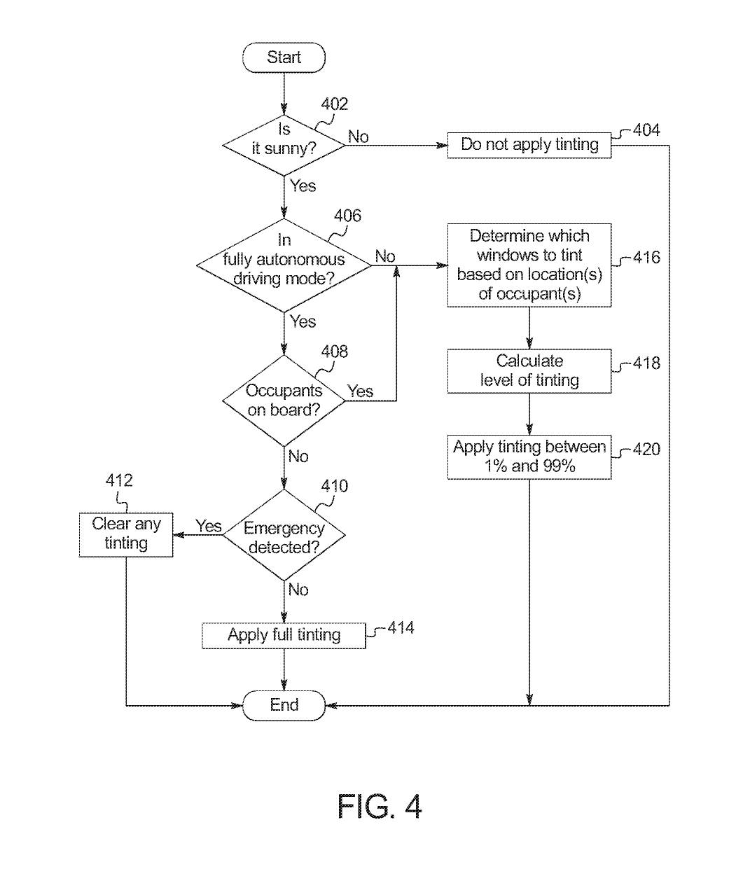

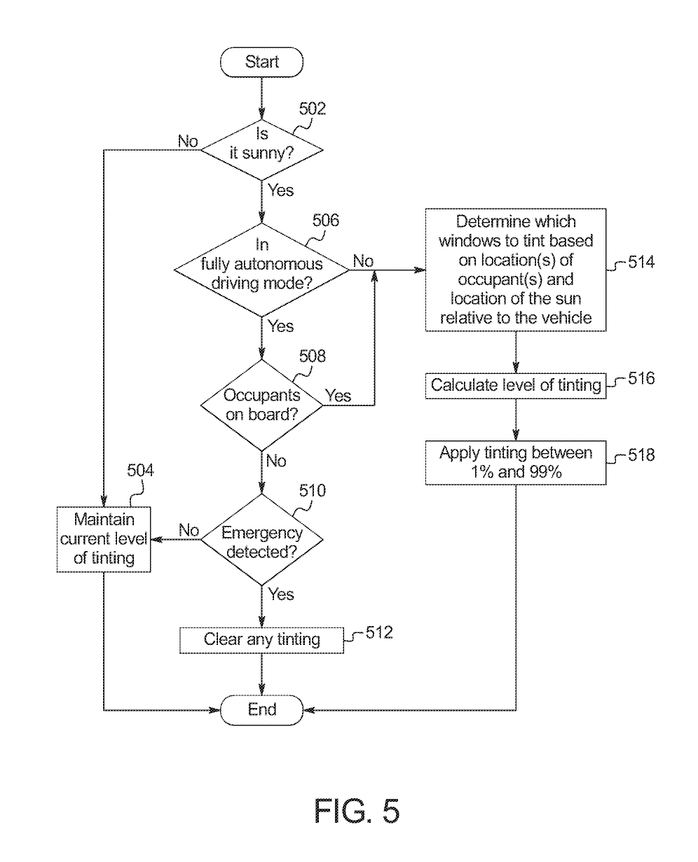

FIG. 3 is a flowchart of a method to regulate the temperature of a cabin of the autonomous vehicle 100 of FIG. 1, which may be implemented by the electronic components 200 of FIG. 2. Initially, at block 302, the tint controller 128 determines the temperature difference (ΔT) between the external ambient temperature (T_{X}) and the desired internal temperature (T_{I}). At block 304, the tint controller 128 determines whether the temperature difference (ΔT) is greater than a threshold. When the temperature difference (ΔT) is greater than the threshold, the method continues at block 306. When the temperature difference (ΔT) is less than the threshold, the method continues at block 308. At block 306, the tint controller 128 controls the photochromic controls 122 associated with the windows 124 to block solar radiation (e.g., blocking mode). An examples method to block the solar radiation is discussed in connection with FIG. 4 below. At block 308, the tint controller 128 controls the photochromic controls 122 associated with the windows 124 to cultivate solar radiation (e.g., cultivation mode). An examples method to cultivate the solar radiation is discussed in connection with FIG. 5 below.

FIG. 4 is a flowchart of a method to manage solar radiation into the cabin of the autonomous vehicle 100, which may be implemented by the electronic components 200 of FIG. 2. At block 402, the tint controller 128 determines whether the external area around the autonomous vehicle 100 is sunny based on the location of the autonomous vehicle 100, information from the weather server 126, and/or images captured by the external camera 106a, etc. When the external area around the autonomous vehicle 100 is sunny, the method continues at block 406. Otherwise, when the external area around the autonomous vehicle 100 is not sunny, the method continues at block 404. At block 404, the tint controller 128 does not adjust the tinting of the windows 124.

At block 406, the tint controller 128 determines whether the autonomous vehicle 100 is currently in a fully autonomous mode. When the autonomous vehicle 100 is currently in a fully autonomous mode, the method continues to block 408. Otherwise, when the autonomous vehicle 100 is not currently in a fully autonomous mode, the method continues at block 416. At block 408, the tint controller 128 determines whether there are occupants inside the cabin (e.g., via the camera(s) 104a and/or the weight sensor(s) 104b, etc.). When there are occupants in the cabin, the method continues at block 416. Otherwise, when there are not occupants in the cabin, the method continues at block 410.

At block 410, the tint controller 128 determines whether there is an emergency detected. When an emergency is detected, the method continues at block 412. Otherwise, when an emergency is not detected, the method continues at block 414. At block 412, the tint controller 128 clears any tinting (e.g., sets transparency to 100%) to the windows 124. At block 414, the tint controller 128 sets the windows 124 to be fully tinted (e.g., set transparency to 0%).

At block 416, the tint controller 128 determines which windows 124 to tint based on the location(s) of the occupant(s) and/or the location of the sun relative to the windows 124. At block 418, the tint controller 128 determines a level of tinting for the windows selected at block 416. For example, the tint controller 128 may apply 70% transparency to the windshield and 50% transparency to the other windows 124 that are in the sunlight. At block 420, the tint controller 128 applies the tint determined at block 418 to the windows 124 (e.g., between 1% transparency and 99% transparency, etc.).

FIG. 5 is a flowchart of a method to cultivate solar radiation into the cabin of the autonomous vehicle 100 of FIG. 1, which may be implemented by the electronic components 200 of FIG. 2. At block 502, the tint controller 128 determines whether the external area around the autonomous vehicle 100 is sunny based on the location of the autonomous vehicle 100, information from the weather server 126, and/or images captured by the external camera 106a, etc. When the external area around the autonomous vehicle 100 is sunny, the method continues at block 506. Otherwise, when the external area around the autonomous vehicle 100 is not sunny, the method continues at block 504. At block 504, the tint controller 128 does not adjust the tinting of the windows 124.

At block 506, the tint controller 128 determines whether the autonomous vehicle 100 is currently in a fully autonomous mode. When the autonomous vehicle 100 is currently in a fully autonomous mode, the method continues to block 508. Otherwise, when the autonomous vehicle 100 is not currently in a fully autonomous mode, the method continues at block 514. At block 508, the tint controller 128 determines whether there are occupants inside the cabin (e.g., via the camera(s) 104a and/or the weight sensor(s) 104b, etc.). When there are occupants in the cabin, the method continues at block 514. Otherwise, when there are not occupants in the cabin, the method continues at block 510.

At block 510, the tint controller 128 determines whether there is an emergency detected. When an emergency is detected, the method continues at block 512. Otherwise, when an emergency is not detected, the method continues at block 504. At block 512, the tint controller 128 clears any tinting (e.g., sets transparency to 100%) to the windows 124.

At block 514, the tint controller 128 determines which windows 124 to tint based on the location(s) of the occupant(s) and/or the location of the sun relative to the windows 124. For example, the tint controller 128 may determine to apply tinting to the windshield and not apply tinting to the other windows 124. At block 516, the tint controller 128 determines a level of tinting for the windows selected at block 514. For example, the tint controller 128 may determine to apply a 70% transparency to the windshield, 50% transparency to window(s) 124 proximate the occupant(s), and 100% transparency to the other windows 124. At block 518, the tint controller 128 applies the tint determined at block 516 to the windows 124 (e.g., between 1% transparency and 100% transparency, etc.).

The flowcharts of FIGS. 3, 4, and 5 are representative of machine readable instructions stored in memory (such as the memory 206 of FIG. 2) that comprise one or more programs that, when executed by a processor (such as the processor 204 of FIG. 4), cause the autonomous vehicle 100 to implement the example tint controller 128 of FIGS. 1 and 2. Further, although the example program(s) is/are described with reference to the flowcharts illustrated in FIGS. 3, 4, and 5, many other methods of implementing the example tint controller 128 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
photochromic windows;
a processor to:
determine a difference between an external ambient temperature and a cabin temperature;
when the difference is greater than a threshold, individually set tint levels on the photochromic windows to reduce a sun load on an interior of vehicle based on a driving mode and occupancy; and
in response to detecting a emergency, clear the tint levels on all the photochromic windows.

2. The vehicle of claim 1, wherein the processor is to individually set the tint levels on the photochromic windows to reduce the sun load when the difference is greater than the threshold and when the weather is sunny.

3. The vehicle of claim 1, wherein the driving mode is one of an autonomous mode and a manual mode.

4. The vehicle of claim 3, wherein when the driving mode is the autonomous mode and the vehicle is empty, set at least one of the photochromic windows to be fully tinted.

5. The vehicle of claim 1, wherein the processor is to, when the difference is less than the threshold, individually set the tint levels on the photochromic windows to increase the sun load on the interior of vehicle based on the driving mode and the occupancy.

6. The vehicle of claim 5, wherein the driving mode is one of an autonomous mode and a manual mode.

7. The vehicle of claim 6, wherein when the driving mode is the autonomous mode and the vehicle is empty, set at least one of the photochromic windows to be not tinted.

8. The vehicle of claim 1, wherein the processor is to estimate the sun load on the interior of the vehicle based on weather data for an area around the vehicle and an orientation of the vehicle.

9. The vehicle of claim 1, including a camera to capture images of an area external to the vehicle, and wherein the processor is to estimate the sun load on the interior of the vehicle based on the images captured by the camera.

10. The vehicle of claim 1, wherein the processor is to, in response to receiving a request to open one of the photochromic windows, open one of the photochromic windows that is not tinted.

11. A method to conserve power in a vehicle, the method comprising:
determining, with a processor, a difference between an external ambient temperature and a cabin temperature;
when the difference is greater than a threshold, setting, via photochromic controllers, tint levels on one or more photochromic windows of the vehicle based on a driving mode and occupancy to reduce power consumption by a heating and air conditioning system of the vehicle; and
in response to detecting a emergency, clear, with the photochromic controllers, the tint levels on all the photochromic windows.

12. The vehicle of claim 11, including individually setting the tint levels on the photochromic windows to reduce the effect of a sun load when the difference is greater than the threshold and when the weather is sunny.

13. The vehicle of claim 11, wherein the driving mode is one of an autonomous mode and a manual mode.

14. The vehicle of claim 13, including when the driving mode is the autonomous mode and the vehicle is empty, setting at least one of the photochromic windows to be fully tinted.

15. The vehicle of claim 11, including when the difference is less than the threshold, setting the tint levels on at least one of the photochromic windows to increase the effect of a sun load on an interior of vehicle based on the driving mode and the occupancy.

16. The vehicle of claim 15, wherein the driving mode is one of an autonomous mode and a manual mode.

17. The vehicle of claim 16, including when the driving mode is the autonomous mode and the vehicle is empty, setting at least one of the photochromic windows to be fully transparent.

18. The vehicle of claim 11, including estimating a sun load on the interior of the vehicle based on weather data for an area around the vehicle and an orientation of the vehicle.

19. The vehicle of claim 11, including estimating a sun load on the interior of the vehicle based on images of an area external to the vehicle captured by a camera.

20. The vehicle of claim 11, including, in response to receiving a request to open one of the photochromic windows, opening at least one of the photochromic windows based on its tint level.
